(19) United States
(12) Patent Application Publication
(10) Pub. No.: US 2003/0157372 A1
(43) Pub. Date: Aug. 21, 2003

(54) Magnetic recording medium

(75) Inventors: Takako Ozawa, Kanagawa (JP); Hiroaki Doushita, Kanagawa (JP); Takeshi Harasawa, Kanagawa (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/279,026

(22) Filed: Oct. 24, 2002

(30) Foreign Application Priority Data
Oct. 25, 2001 (JP) 2001-328137

(51) Int. Cl. B32B 3/02

(52) U.S. Cl. 428/694 BP; 428/694 BH; 428/65.3

(57) ABSTRACT

Provided is a magnetic recording medium with improved running properties and durability employing hexagonal ferrite. The magnetic recording medium comprises a nonmagnetic layer comprising a nonmagnetic powder and a binder and a magnetic layer comprising a hexagonal ferrite powder and a binder in this order on a support. Said magnetic layer has a surface lubricant index ranging from 1.3 to 5.0 and a center surface average roughness SRa of a 40×40 μm area as measured by atomic force microscope (AFM) being equal to or less than 4 nm.

### FIELD OF THE INVENTION

The present invention relates to a magnetic recording medium excellent in running properties and electromagnetic characteristics.

### RELATED ART

With the expansion in information processing, a strong need has developed in industries of magnetic disks and magnetic tapes with increased recording capacity and reduced size, with strong demand for the development of higher recording density and capacity. Conventionally, ferromagnetic metal powder, iron oxide, Co iron oxide, cobalt oxide, and hexagonal ferrite powder have been employed in the magnetic layers of magnetic recording media. Among theses hexagonal ferrite powder is known to have good high-density recording characteristics.

Improvement in magnetic heads has been progressed for achieving high density recording. The magnetic heads based on the operative principle of electromagnetic induction (magnetoinductive heads) that have been conventionally employed require a large number of coil windings in the reproduction head to achieve large reproduction output. However, this also results in increases in both inductance and resistance at high frequency, creating a problem in the form of decreased reproduction output and limiting high density recording and reproduction

By contrast, reproduction heads operating on the principle of magnetoresistance (MR) have been proposed and their use with hard disks and the like has already begun. Magnetoresistive heads (MR heads) yield several times the reproduction output of magnetoinductive heads without the use of an induction coil. Thus, they afford a significant reduction in device noise such as impedance noise and can be anticipated to improve high-density recording and reproduction characteristics.

Improving such magnetic heads requires advances in optimization of magnetic recording media. Further advances in high densification require increasing the magnetic flux density of the magnetic recording medium itself However, when the magnetic flux density of the magnetic recording medium is raised, despite increased output during reproduction with MR heads, there is an even greater increase in noise, resulting in the problem of decreased C/N ratio. Further, there is a problem in that a shift in the linear relation between magnetic intensity and resistance tends to develop in MR heads, with the C/N ratio also decreasing in the high frequency range.

In response to this problem, the obtaining of a high C/N ratio in reproduction with MR heads has been disclosed by employing hexagonal ferrite with good high density recording characteristics and prescribing the number of protrusions on the magnetic layer surface, the volume of reversal of magnetization, and coercivity (Japanese Unexaimined Patent Publication (KOKAI) Heisei No. 10-302248).

However, the problems of poor durability (still characteristics) and running properties (coefficient of friction) still remain. Further improvement is considered necessary.

Accordingly, it is an object of the present invention is to provide a magnetic recording medium with improved running properties and durability employing hexagonal ferrite.

### SUMMARY OF THE INVENTION

The above-stated object of the present invention is achieved by a magnetic recording medium comprising a nonmagnetic layer comprising a nonmagnetic powder and a binder and a magnetic layer comprising a hexagonal ferrite powder and a binder in this order on a support, wherein

said magnetic layer has a surface lubricant index ranging from 1.3 to 5.0 and a center surface average roughness SRa of a 40×40 μm area as measured by atomic force microscope (AFM) being equal to or less than 4 nm.

An MR head is desirably employed as the recording and reproduction means for the magnetic recording medium of the present invention.

[Hexagonal Ferrite]

The present invention employs hexagonal ferrite as the magnetic powder in the magnetic layer. Hexagonal ferrite has good high density characteristics and is particularly desirable for reproduction with MR heads.

Examples of hexagonal ferrite employed in the present invention are various substitution products of barium ferrite, strontium ferrite, lead ferrite, and calcium ferrite, and Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated in addition to the preseribed atoms: Al, Si, S, Sc, Ti, V, Cr, Cu, Y, Mo, Rh, Pd, Ag, Sn, Sb, Te, Ba, Ta, W, Re, Au, Hg, Pb, Hi, La, Ce, Pr, Nd, P, Co, Mn, Zn, Ni, Sr, B, Ge, Nb, and the like. Compounds to which elements such as Co—Zn, Co—Ti, Co—Ti—Zr, Co—Ti—Zn, Ni—Ti—Zn, Nb—Zn—Co, Sb—Zn—Co, and Nb—Zn have been added may generally also be employed. They may comprise specific impurities depending on the starting materials and manufacturing methods.

The particle size is, as a hexagonal plate diameter, 10 to 100 nm, preferably 10 to 60 nm, more preferably 10 to 50 nm. In particular, when reproducing with a magnetoresistive head to increase track density, noise must be kept low, and a plate diameter equal to or less than 40 nm is desirable and equal to or less than 35 nm is particularly preferred. However, stable magnetization cannot be achieved due to thermal fluctuation at less than 10 nm, and noise increases when exceeding 100 nm. Both cases are unsuitable for high-density magnetic recording. A plate ratio (plate diameter/plate thickness) of 1 to 15 is desirable and 1 to 7 is preferred. Small plate ratio is desirable because a high fill property in the magnetic layer increase, but adequate orientation cannot be achieved. If a plate ratio exceeds 15, noise increases due to stacking of particles. The specific surface area by BET method within the above-mentioned particle size ranges from 10 to 100 m²/g. The specific surface area almost corresponds to an arithmetic value from the particle plate diameter and the plate thickness. Narrow distributions of particle plate diameter and thickness are normally preferred. Although difficult to render in number form, 500 particles can be randomly measured in a TEM photograph of particles to make a comparison. This distribution is often not a normal distribution. However, when expressed as the standard deviation to the average size, σ/average size=0.1 to 2.0. The particle producing reaction system is rendered as uniform as possible and the particles produced are subjected to a distribution-enhancing treatment to achieve a sharp particle size distribution. For example, methods such as selectively dissolving ultrafine particles in an acid solution are known. The coercive force (Hc) measured in the magnetic material ranging from 39.8 to 398 kA/m (500 to 5000 Oe) normally can be achieved. High Hc is advantageous to high-density recording, but it is limited by the capacity of recording head. In the present invention, the Hc of magnetic material ranges about 159 to 318 kA/m (2000 to 4000 Oe), preferably 175 to 279 kA/m (2200 to 3500 Oe). If the saturation magnetization of the head exceeds 1.4 T, it is preferably equal to or higher than 175 kA/m (2200 Oe). The Hc can be controlled by particle size (plate diameter and plate thickness), the types and quantities of elements contained, substitution sites of the element, the particle producing reaction conditions, and the like. The saturation magnetization (σ s) is 40 to 80 A•m²/kg (40 to 80 emu/g). The higher saturation magnetization (σ s) is preferred, however, it tends to decrease with decreasing particle size. Known methods of improving saturation magnetization (σ s) are combining spinel ferrite with magnetoplumbite ferrite, selection of the type and quantity of elements incorporated, and the like. It is also possible to employ W-type hexagonal ferrite. When dispersing the magnetic material, the surface of the magnetic material particles is processed with a substance suited to a dispersion medium and a polymer. Both organic and inorganic compounds can be employed as surface treatment agents. Examples of the principal compounds are oxides and hydroxides of Si, Al, P, and the like; various silane coupling agents; and various titanium coupling agents. The quantity of surface treatment agent added ranges from 0.1 to 10 percent relative to the magnetic material. The pH of the magnetic material is also important to dispersion. A pH of about 4 to 12 is usually optimum for the dispersion medium and polymer. From the perspective of the chemical stability and storage properties of the medium, a pH of about 6 to 11 can be selected. Moisture contained in the magnetic material also affects dispersion. There is an optimum level for the dispersion medium and polymer, usually selected from the range of 0.01 to 2.0 percent. Methods of manufacturing the hexagonal ferrite include: (1) a vitrified crystallization method consisting of mixing into a desired ferrite composition barium oxide, iron oxide, and a metal oxide substituting for iron with a glass forming substance such as boron oxide; melting the mixture; rapidly cooling the mixture to obtain an amorphous material; reheating the amorphous material; and refining and comminuting the product to obtain a barium ferrite crystal powder; (2) a hydrothermal reaction method consisting of neutralizing a barium ferrite composition metal salt solution with an alkali; removing the by-product; heating the liquid phase to 100° C. or greater; and washing, drying, and comminuting the product to obtain barium ferrite crystal powder; and (3) a coprecipitation method consisting of neutralizing a barium ferrite composition metal salt solution with an alkali; removing the by-product; drying the product and processing it at equal to or less than 1,100° C.; and comminuting the product to obtain barium ferrite crystal powder. However, any manufacturing method can be selected in the present invention.

[Surface Lubricant Index]

In the magnetic recording medium of the present invention, the surface lubricant index in the magnetic layer falls within a range of 1.3 to 5.0, preferably within a range of 1.3 to 3.0. When the surface lubricant index is less than 1.3, still characteristics deteriorate. And when 5.0 is exceeded, the coefficient of friction increases and running stability decreases.

The surface lubricant index indicates the quantity of lubricant present on the surface of the magnetic layer and can be controlled by optimizing the blend of lubricants. Preferred lubricants are fatty acids and fatty esters. The quantity of lubricant present on the surface can be further controlled through the compatibility of the lubricant with the binder in which the magnetic material is dispersed. When compatibility is high, the lubricant melts into the magnetic layer, reducing the quantity on the surface. By contrast, when compatibility is low, the quantity on the surface increases. Accordingly, from the perspective of compatibility, the surface lubricant index can be controlled by optimizing the type of lubricant and type of binder, optimizing the blending ratio (the ratio of vinyl chloride-urethane resin-curing agent) of the binder resin composition, and optimizing the P/B ratio (the ratio of inorganic powder such as magnetic material to the binder resin). Further, when the lubricant is readily adsorbed by the magnetic material, reduction of the lubricating material on the surface due to that components adsorbed by the magnetic material is present in the inner of magnetic layer can be exploited by optimizing the type of lubricant and type of magnetic material (surface area, pH, and quantity of Al, Si, or the like in the oxide film) to control the quantity of surface lubricant.

The surface lubricant index can also be controlled by drying conditions following coating. Generally, the drying speed of the coating film can be accelerated to increase the rate of movement of organic solvents being evaporated out of the coating film, with lubricant dissolved in these solvents moving to the coating surface along with the solvents, increasing the quantity of lubricant on the surface. Additionally, when the drying temperature is increased to accelerate the drying speed, if volatile lubricants are employed, the lubricants also evaporate, reducing the quantity of lubricants on the surface. It is also possible to effect control through calendering conditions, such as the temperature, pressure, and hardness of calendering rolls; increasing any one of these tends to increase the quantity of surface lubricant.

The surface lubricant index of the surface of the magnetic recording medium is an index indicating the quantity of lubricant on the medium surface that is measured in the following manner.

One method of measuring substances present on the surface is by Auger Electron Spectroscopy. Auger Electron Spectroscopy permits the analysis of elements to a depth of several tens of Angstroms from the surface, making it possible to determine the elements that are present, and their stoichiometric relation, on the extreme outer surface.

The quantity of the element carbon measured by Auger Electron Spectroscopy in a magnetic recording medium corresponds to the quantities of lubricant and binder present on the medium surface. At the same time, the quantity of the element iron measured by Auger Electron Spectroscopy corresponds to the quantity of magnetic material present on the medium surface. It is possible to calculate the ratio of the two, C/Fe (a).

The quantity of the element carbon measured after removing the lubricant from the magnetic recording medium corresponds to the quantity of binder resin on the medium surface. The ratio with element iron at this time, C/Fe (b), can be calculated. The surface lubricant index of the present invention is denoted by (C/Fe(a))/(C/Fe(b)).

Lubricant can be removed from the medium by immersing the medium in n-hexane to extract and remove lubricant not adsorbed onto magnetic material, followed by reacting lubricant adsorbed onto magnetic material with a silylating agent to obtain derivatives that are then extracted and removed.

[Center Surface Average Roughness, SRa]

The center surface average roughness (SRa) of an area of 40×40 82 m as measured by Atomic Force Microscope (AFM) on the magnetic layer of the present invention is equal to or less than 4 nm, preferably equal to or less than 3 nm. When the center surface average roughness SRa of an area 40×40 μm as measured by AFM exceeds 4 nm, spacing losses occur and carrier proximity noise increases, causing the S/N ratio to drop.

To achieve a magnetic layer center surface average roughness SRa within the above-stated range, it is important to prevent aggregation of granular components in the magnetic layer. Aggregation can be prevented by dispersion of the magnetic layer liquid in a sand mill or the like for an adequate dispersion period. However, excessive dispersion sometimes invites reaggregation, so the dispersion period is from 10 to 30 hours, preferably from 15 to 25 hours, and more preferably, from 17 to 25 hours.

The center surface average roughness (SRa) of the magnetic layer can also be controlled through calendering conditions, that is, calendering pressure and temperature and the type and number of calender rolls employed. The calendering pressure is 2,450 to 3,430 N/cm (260 to 350 kg/cm), preferably 2,744 to 3,234 N/cm (280 to 330 kg/cm). Maintaining the calendering pressure within the above-stated range yields a smooth magnetic layer surface. Increasing the calendering temperature can yield a smooth surface, but since an excessively high temperature tends to volatize surface lubricants, the calendering temperature is 60 to 130° C., preferably 85 to 110° C. The center surface average roughness SRa of the magnetic layer can also be controlled through the hardness of the surface of the calender roll material. When calender rolls of resin are employed, the magnetic layer surface becomes rough, and when rolls of metal are employed, the magnetic layer surface becomes smooth. Various combinations of calender rolls are also possible; the number and combination of different types of rolls may also be used to control the center surface average roughness SRa of the magnetic layer.

To control the center surface average roughness SRa of the magnetic surface, it is also important to employ granular components contained in the magnetic layer, that is, hexagonal ferrite powder, abrasives, and carbon black, of finer particle size than is conventionally the case. It is also quite important to maintain a high degree of dispersion of powders in the magnetic coating material and/or nonmagnetic coating material and reduce the surface roughness of the support to a level lower than is conventionally the case. The particle size of the hexagonal ferrite, as a plate diameter, is equal to or less than 40 nm, preferably equal to or less than 35 nm. The particle diameter of the abrasive is from 0.1 to 0.5 μm, preferably from 0.1 to 0.25 μm, and the abrasive is normally employed in a proportion of 2 to 50 mass parts, preferably 5 to 30 mass parts, per 100 mass parts of hexagonal ferrite powder.

When carbon black is employed, the particle diameter of the carbon black is desirably from 5 to 300 nm, and it is desirably employed in a proportion of 0.1 to 30 mass percent per the hexagonal ferrite powder.

In the present invention, abrasives can be contained in the magnetic layer. Known materials, chiefly with a Mohs' hardness equal to or higher than 6, such as α-alumina having an α-conversion rate equal to or higher than 90 percent, β-alumina, silicon carbide, chromium oxide, cerium oxide, α-iron oxide, corundum, artificial diamond, silicon nitride, titanium carbide, titanium oxide, silicon dioxide, and boron nitride, may be used singly or in combination as abrasives. Further, a composite comprising two or more of these abrasives (an abrasive obtained by surface-treating one abrasive with another) may also be used. Although these abrasives may contain compounds and elements other than the main component or element in some cases, there is no change in effect so long as the main component constitutes equal to or higher than 90 mass percent. A tap density of 0.3 to 2 g/mL, a moisture content of 0.1 to 5 mass percent, a pH of 2 to 11, and a specific surface area of 1 to 30 m²/g are desirable. The abrasive employed in the present invention may be any of acicular, spherical, or cubic in shape, but shapes that are partially angular have good abrasion properties and are thus preferred. Specific examples of abrasives are: AKP-20, AKP-30, AKP-50, HIT-50, HIT-55, HIT-60A, HIT-70 and HIT-100 from Sumitomo Chemical Co., Ltd.; G5, G7 and S-1 from Nippon Chemical Industrial Co., Ltd.; TF-100 and TF-140 from Toda Kogyo Corp. The type, quantity, and combination of abrasives may be varied in the magnetic layer and nonmagnetic layer, with different abrasives being employed for different purposes. These abrasives may be added to the magnetic coating material after having been predispersed in binder.

Carbon black may be added to the magnetic layer of the present invention. Examples of types of carbon black that are suitable for use are: furnace black for rubber, thermal for rubber, black for coloring, and acetylene black. It is preferable that the specific surface area is 5 to 500 m²/g, the DBP oil absorption capacity is 10 to 400 ml/100 g, the particle diameter is 5 to 300 nm, the pH is 2 to 10, the moisture content is 0.1 to 10 mass percent, and the tap density is 0.1 to 1 g/ml. Specific examples of types of carbon black employed in the present invention are: BLACK PEARLS 2000, 1300, 1000, 900, 800, 700 and VULCAN XC-72 from Cabot Corporation; #80, #60, #55, #50 and #35 manufactured by Asahi Carbon Co., Ltd.; #2400B, #2300, #900, #1000, #30, #40 and #10B from Mitsubishi Chemical Corporation; and CONDUCTEX SC, RAVEN 150, 50, 40 and 15 from Columbia Carbon Co., Ltd. The carbon black employed may be surface treated with a dispersant or grafted with resin, or have a partially graphite-treated surface. The carbon black may be dispersed in advance into the binder prior to addition to the magnetic coating material. These carbon blacks may be used singly or in combination.

Carbon black works to prevent static, reduce the coefficient of friction, impart light-blocking properties, enhance film strength, and the like in the magnetic layer; the properties vary with the type of carbon black employed. Accordingly, the type, quantity, and combination of carbon blacks employed in the present invention may be determined separately for the magnetic layer and the nonmagnetic layer based on the objective and the various characteristics stated above, such as particle size, oil absorption capacity, electrical conductivity, and pH, and be optimized for each layer. For example, the Carbon Black Handbook compiled by the Carbon Black Association may be consulted for types of carbon black suitable for use in the magnetic layer of the present invention.

Conventionally known thermoplastic resins, thermosetting resins, reactive resins and mixtures thereof may be employed as binders employed in the present invention. The thermoplastic resins employed may have a glass transition temperature of −100 to 150° C., have a number average molecular weight of 1,000 to 200,000, preferably 10,000 to 100,000, and have a degree of polymerization of about 50 to 1,000.

Examples of the thermoplastic resins are polymers and copolymers comprising structural units in the form of vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, vinyl acetal, and vinyl ether; polyurethane resins; and various rubber resins. Further, examples of thermosetting resins and reactive resins are phenol resins, epoxy resins, polyurethane cured resins, urea resins, melamine resins, alkyd resins, acrylic reactive resins, formaldehyde resins, silicone resins, epoxy polyamide resins, mixtures of polyester resins and isocyanate prepolymers, mixtures of polyester polyols and polyisocyanates, and mixtures of polyurethane and polyisocyanates. These resins are described in detail in the Handbook of Plastics published by Asakura Shoten. Further, a conventionally known electron-beam curing resin can be employed in the individual layers. These examples and methods of manufacturing them are described in detail in Japanese Unexamined Patent Publication (KOKAI) Showa No. 62-256219. The above-described resins may be employed singly or in combination. The preferred resin is a combination of polyurethane resin and one or more selected from vinyl chloride resin, vinyl chloride vinyl acetate copolymer, vinyl chloride vinyl acetate vinyl alcohol copolymer, and vinyl chloride vinyl acetate maleic anhydride copolymer; or a resin obtained by mixing polyisocyanate into one of the above.

Known polyurethane resins may be employed, such as polyester polyurethane, polyether polyurethane, polyether polyester polyurethane, polycarbonate polyurethane, polyester polycarbonate polyurethane, and polycaprolactone polyurethane. A binder obtained by incorporating as needed one or more polar groups selected from —COOM, —SO₃M, —OSO₃M, —P═O(OM)₂, and —O—P═O(OM)₂ (where M denotes a hydrogen atom or an alkali metal base), —OH, —NR₂, —N⁺R₃ (where R denotes a hydrocarbon group), epoxy group, —SH, and —CN into any of the above-listed binders by copolymerization or addition reaction to improve dispersion properties and durability is desirably employed. The quantity of such a polar group ranges from 10⁻¹ to 10⁻⁸ mol/g, preferably from 10⁻² to 10⁻⁶ mol/g.

Specific examples of the binders employed in the present invention are VAGH, VYHH, VMCH, VAGF, VAGD, VROH, VYES, VYNC, VMCC, XYHL, XYSG, PKHH, PKHJ, PKHC, and PKFE from Union Carbide Corporation; MPR-TA, MPR-TA5, MPR-TAL, MPR-TSN, MPR-TMF, MPR-TS, MPR-TM, and MPR-TAO from Nisshin Kagaku Kogyo K. K.; 1000W, DX80, DX81, DX82, DX83, and 100FD from Denki Kagaku Kogyo K. K.; MR-104, MR-105, MR110, MR100, MR555, and 400X-110A from Nippon Zeon Co., Ltd.; Nippollan N2301, N2302, and N2304 from Nippon Polyurethane Co., Ltd.; Pandex T-5105, T-R3080, T-5201, Burnock D-400, D-210-80, Crisvon 6109, and 7209 from Dainippon Ink and Chemicals Incorporated.; Vylon UR8200, UTR8300, UR-8700, RV530, and RV280 from Toyobo Co., Ltd.; Daipheramine 4020, 5020, 5100, 5300, 9020, 9022, and 7020 from Dainichiseika Color & Chemicals Mfg. Co., Ltd.; MX5004 from Mitsubishi Chemical Corporation; Sanprene SP-150 from Sanyo Chemical Industries, Ltd.; and Saran F310 and F210 from Asahi Chemical Industry Co., Ltd.

The quantity of binder employed in the nonmagnetic layer and the magnetic layer ranges from 5 to 50 percent, preferably from 10 to 30 percent, relative to the nonmagnetic powder or magnetic powder. When employing vinyl chloride resin, the quantity is preferably 5 to 30 percent; when employing polyurethane resin, 2 to 20 percent; and when employing polyisocyanate, 2 to 20 percent. They are preferably employed in combination. However, for example, when head corrosion occurs due to the release of trace amounts of chlorine, polyurethane alone or just polyurethane and isocyanate may be employed. When polyurethane is employed in the present invention, the glass transition temperature ranges from −50 to 150° C., preferably from 0 to 100° C.; the elongation at break desirably ranges from 100 to 2,000 percent; the stress at break desirably ranges from 4.9×10⁻⁴ to 9.8×10⁻² GPa (0.05 to 10 kg/mm²); and the yield point desirably ranges from 4.9×10−4 to 9.8×10⁻² GPa (0.05 to 10 kg/mm²).

The magnetic recording medium employed in the present invention comprises at least two layers of the lower layer (nonmagnetic layer) and the magnetic layer. Accordingly, the quantity of binder; the quantity of vinyl chloride resin, polyurethane resin, polyisocyanate, or some other resin in the binder; the molecular weight of each of the resins forming the magnetic layer; the quantity of polar groups; or the physical characteristics or the like of the above-described resins can naturally be different in the nonmagnetic layer and each of the magnetic layers as required. These should be optimized in each layer. Known techniques for a multilayered magnetic layer may be applied. For example, when the quantity of binder is different in each layer, increasing the quantity of binder in the magnetic layer effectively decreases scratching on the surface of the magnetic layer. To achieve good head touch, the quantity of binder in the nonmagnetic layer can be increased to impart flexibility.

Examples of polyisocyanates suitable for use in the present invention are tolylene diisocyanate, 4,4′-diphenylmethane diisocyanate, hexamethylene diisocyanate, xylylene diisocyanate, naphthylene 1,5-diisocyanate, o-toluidine diisocyanate, isophorone diisocyanate, triphenylmethane triisocyanate, and other isocyanates; products of these isocyanates and polyalcohols; polyisocyanates produced by condensation of isocyanates; and the like. These isocyanates are commercially available under the following trade names, for example: Coronate L, Coronate HL, Coronate 2030, Coronate 2031, Millionate MR and Millionate MTL manufactured by Nippon Polyurethane Industry Co. Ltd.; Takenate D-102, Takenate D-110N, Takenate D-200 and Takenate D-202 manufactured by Takeda Chemical Industries Co. Ltd.; and Desmodule L, Desmodule IL, Desmodule N and Desmodule HL manufactured by Sumitomo Bayer Co. Ltd. They can be used singly or in combinations of two or more in each of layers by exploiting differences in curing reactivity.

Additives imparting lubricating, antistatic, dispersive and plastic effects and the like may be employed in the present invention. Examples are: molybdenum disulfide; tungsten graphite disulfide; boron nitride; graphite fluoride; silicone oils; silicones having a polar group; fatty acid-modified silicones; fluorine-containing silicones; fluorine-containing alcohols; fluorine-containing esters; polyolefins; polyglycols; alkylphosphoric esters and their alkali metal salts; alkylsulfuric esters and their alkali metal salts; polyphenyl ethers; fluorine-containing alkylsulfuric esters and their alkali metal salts; monobasic fatty acids having 10 to 24 carbon atoms (which may contain an unsaturated bond or may be branched) and metal (e.g., Li, Na, K, Cu) salts thereof; monohydric, dihydric, trihydric, tetrahydric, pentahydric and hexahydric alcohols having 12 to 22 carbon atoms (which may contain an unsaturated bond or be branched); alkoxy alcohols having 12 to 22 carbon atoms; monofatty esters, difatty esters, or trifatty esters comprising a monobasic fatty acid having 10 to 24 carbon atoms (which may contain an unsaturated bond or be branched) and any one from among a monohydric, dihydric, trihydric, tetrahydric, pentahydric or hexahydric alcohol having 2 to 12 carbon atoms (which may contain an unsaturated bond or be branched); fatty esters of monoalkyl ethers of alkylene oxide polymers; fatty acid amides having 8 to 22 carbon atoms; aliphatic amines having 8 to 22 carbon atoms; and the like. However, as mentioned above, the surface lubricant index is set within the prescribed range in the present invention.

Specific examples of the above compounds are: lauric acid, myristic acid, palmitic acid, stearic acid, behenic acid, butyl stearate, oleic acid, linolic acid, linolenic acid, elaidic acid, octyl stearate, amyl stearate, isooctyl stearate, octyl myristate, butoxyethyl stearate, anhydrosorbitan monostearate, anhydrosorbitan distearate, anhydrosorbitan tristearate, oleyl alcohol and lauryl alcohol. It is also possible to employ nonionic surfactants such as alkylene oxide-based surfactants, glycerin-based surfactants, glycidol-based surfactants and alkylphenolethylene oxide adducts; cationic surfactants such as cyclic amines, ester amides, quaternary ammonium salts, hydantoin derivatives, heterocycles, phosphoniums, and sulfoniums; anionic surfactants comprising acid groups, such as carboxylic acid, sulfonic acid, phosphoric acid, sulfuric ester groups, and phosphoric ester groups; and ampholytic surfactants such as amino acids, amino sulfonic acids, sulfuric or phosphoric esters of amino alcohols, and alkyl betaines.

Details of these surfactants are described in Surfactants Handbook (published by Sangyo Tosho Co., Ltd.). These lubricants, antistatic agents and the like need not be 100 percent pure and may contain impurities, such as isomers, unreacted material, by-products, decomposition products, and oxides in addition to the main components. These impurities preferably comprise equal to or less than 30 percent, and more preferably equal to or less than 10 percent.

The lubricants and surfactants employed in the present invention may be employed differently in the magnetic layer and nonmagnetic layer as needed based on type and quantity. For example, it is conceivable to control bleeding onto the surface through the use in the magnetic layer and the nonmagnetic layer of fatty acids having different melting points, to control bleeding onto the surface through the use of esters having different boiling points and polarities, to improve coating stability by adjusting the amount of surfactant, and to enhance the lubricating effect by increasing the amount of lubricant added to the nonmagnetic layer; this is not limited to the examples given here. All or some of the additives used in the present invention may be added at any stage in the process of manufacturing the magnetic coating liquid. For example, they may be mixed with the ferromagnetic powder before a kneading step; added during a step of kneading the ferromagnetic powder, the binder, and the solvent; added during a dispersing step; added after dispersing; or added immediately before coating. Depending on the objective, part or all of the additives may be applied by simultaneous or sequential coating after the magnetic layer has been applied to achieve a specific purpose. Depending on the objective, the lubricant may be coated on the surface of the magnetic layer after calendering or making slits.

Examples of the trade names of lubricants suitable for use in the present invention are: NAA-102, NAA-415, NAA-312, NAA-160, NAA-180, NAA-174, NAA-175, NAA-222, NAA-34, NAA35, NAA-171, NAA-122, NAA-142, NAA-160, NAA-173K, hydrogenated castor oil fatty acid, NAA-42, NAA-44, Cation SA, Cation MA, Cation AB, Cation BB, Nymeen L-201, Nymeen L-202, Nymeen S-202, Nonion E-208, Nonion P-208, Nonion S-207, Nonion K-204, Nonion NS-202, Nonion NS-210, Nonion HS-206, Nonion L-2, Nonion S-2, Nonion S-4, Nonion O-2, Nonion LP-20R, Nonion PP-40R, Nonion SP-60R, Nonion OP-80R, Nonion OP-85R, Nonion LT-221, Nonion ST-221, Nonion OT-221, Monogly MB, Nonion DS-60, Anon BF, Anon LG, butyl stearate, butyl laurate, and erucic acid, manufactured by NOF Corporation; oleic acid, manufactured Kanto Chemical Co. Ltd; FAL-205 and FAL-123, manufactured by Takemoto Oil & Fat Co.,Ltd.; NJLUB LO, NJLUB IPM, and Sansosyzer E4030, manufactured by New Japan Chemical Co.Ltd.; TA-3, KF-96, KF-96L, KF96H, KF410, KF420, KF965, KF54, KF50, KF56, KF907, KF851, X-22-819, X-22-822, KF905, KF700, KF393, KF-857, KF-860, KF-865, X-22-980, KF-101, KF-102, KF-103, X-22-3710, X-22-3715, KF-910 and KF-3935, manufactured by Shin-Etsu Chemical Co.Ltd.; Armide P, Armide C and Armoslip CP, manufactured by Lion Armour Co.,Ltd.; Duomine TDO, manufactured by Lion Corporation; BA-41G, manufactured by Nisshin Oil Mills, Ltd.; and Profan 2012E, Newpole PE61, Ionet MS-400, Ionet MO-200, Ionet DL-200, Ionet DS-300, Ionet DS-1000 and Ionet DO-200, manufactured by Sanyo Chemical Industries, Ltd.

[Nonmagnetic Layer]

Details of the nonmagnetic layer will be described below.

The nonmagnetic powder employed in the nonmagnetic layer of the present invention is, for example, an inorganic powder, selected from inorganic compounds such as metal oxides, metal carbonates, metal sulfates, metal nitrides, metal carbides, metal sulfides and the like. Examples of inorganic compounds are α-alumina having an α-conversion rate equal to or higher than 90 percent, β-alumina, γ-alumina, θ-alumina, silicon carbide, chromium oxide, cerium oxide, α-iron oxide, hematite, goethite, corundum, silicon nitride, titanium carbide, titanium dioxide, silicon dioxide, tin oxide, magnesium oxide, tungsten oxide, zirconium oxide, boron nitride, zinc oxide, calcium carbonate, calcium sulfate, barium sulfate, and molybdenum disulfide; these may be employed singly or in combination. Particularly desirable due to their narrow particle distribution and numerous means of imparting functions are titanium dioxide, zinc oxide, iron oxide and barium sulfate. Even more preferred are titanium dioxide and et iron oxide. The particle size of these nonmagnetic powders preferably ranges from 0.005 to 0.5 μm, but nonmagnetic powders of differing particle size may be combined as needed, or the particle diameter distribution of a single nonmagnetic powder may be broadened to achieve the same effect. What is preferred most is a particle size in the nonmagnetic powder ranging from 0.01 to 0.2 μm. Particularly when the nonmagnetic powder is a granular metal oxide, a mean particle diameter equal to or less than 0.08 μm is preferred, and when an acicular metal oxide, the major axis length is preferably equal to or less than 0.2 μm, more preferably equal to or less than 0.15 μm, further preferably equal to or less than 0.1 μm. The acicular ratio of the nonmagnetic powder ranges from 2 to 20, preferably from 3 to 10. The tap density ranges from 0.05 to 2 g/ml, preferably from 0.2 to 1.5 g/ml. The moisture content of the nonmagnetic powder ranges from 0.1 to 5 mass percent, preferably from 0.2 to 3 mass percent, further preferably from 0.3 to 1.5 mass percent. The pH of the nonmagnetic powder ranges from 2 to 11, and the pH between 5.5 to 10 is particular preferred. These have a high adsorption property to a polar group, permitting good dispersibility and high mechanical strength of coating.

The specific surface area of the nonmagnetic powder ranges from 1 to 100 m²/g, preferably from 5 to 80 m²/g, further preferably from 10 to 70 m²/g. The crystallite size of the nonmagnetic powder preferably ranges from 0.004 to 1 μm, further preferably from 0.04 to 0.1 μm. The oil absorption capacity using dibutyl phthalate (DEP) ranges from 5 to 100 ml/100 g, preferably from 10 to 80 ml/g, further preferably from 20 to 60 ml/100 g. The specific gravity of the nonmagnetic powder ranges from 1 to 12, preferably from 3 to 6. The shape of the nonmagnetic powder may be any of acicular, spherical, polyhedral, or plate-shaped. The Mohs' hardness is preferably 4to 10. The stearic acid (SA) adsorption capacity of the nonmagnetic powders ranges from 1 to 20 μmol/m², preferably from 2 to 15 μmol/m², further preferably from 3 to 8 μmol/m². The pH between 3 to 6 is preferred. The surface of these nonmagnetic powders is preferably treated with Al₂O₃, SiO₂, TiO₂, ZrO₂, SnO₂, Sb₂O₃, ZnO and Y₂O₃. The surface-treating agents of preference with regard to dispersibility are Al₂O₃, SiO₂, TiO₂, and ZrO₂, and Al₂O₃, SiO₂ and ZrO₂ are further preferable. These may be used singly or in combination. Depending on the objective, a surface-treatment coating layer with a coprecipitated material may also be employed, the coating structure which comprises a first alumina coating and a second silica coating thereover or the reverse structure thereof may also be adopted. Depending on the objective, the surface-treatment coating layer may be a porous layer, with homogeneity and density being generally desirable.

Specific examples of nonmagnetic powders suitable for use in the nonmagnetic layer of the present invention are: Nanotite from Showa Denko K. K.; HIT-100 and ZA-G1 from Sumitomo Chemical Co., Ltd.; α-hematite DPN-250, DPN-250BX, DPN-245, DPN-270BX, DPN-500BX, DBN-SA1 and DBN-SA3 from Toda Kogyo Corp.; titanium oxide TTO-51B, TTO-55A, TTO-55B, TTO-55C, TTO-55S, TTO-55D, SN-100, α-hematite E270, E271, E300 and E303 from Ishihara Sangyo Co., Ltd.; titanium oxide STT-4D, STT-30D, STT-30, STT-65C, and α-hematite α-40 from Titan Kogyo K. K.; MT100S, MT-100T, MT-150W, MT-500B, MT-600B, MT-100F, and MT-500HD from Tayca Corporation; FINEX-25, BF-1, BF-10, BF-20, and ST-M from Sakai Chemical Industry Co., Ltd.; DEFIC-Y and DEFIC-R from Dowa Mining Co., Ltd.; AS2BM and TiO2P25 from Nippon Aerogil; 100A and 500A from Ube Industries, Ltd.; and sintered products of the same. Particular preferable nonmagnetic powders are titanium dioxide and α-iron oxide.

Carbon black can be added additionally to the nonmagnetic layer. Mixing carbon black achieves the known effects of lowering surface resistivity Rs and reducing light transmittance, as well as yielding the desired micro Vickers hardness. Examples of types of carbon black that are suitable for use are furnace black for rubber, thermal for rubber, black for coloring and acetylene black.

The specific surface area of carbon black employed in the nonmagnetic layer ranges from 100 to 500 m²/g, preferably from 150 to 400 m²/g and the DBP oil absorption capacity ranges from 20 to 400 ml/100 g, preferably from 30 to 400 ml/100 g. The particle diameter of carbon black ranges from 5 to 80 nm, preferably from 10 to 50 nm, further preferably from 10 to 40 nm. It is preferable for carbon black that the pH ranges from 2 to 10, the moisture content ranges from 0.1 to 10 percent and the tap density ranges from 0.1 to 1 g/ml. Specific examples of types of carbon black suitable for use in the present invention are: BLACK PEARLS 2000, 1300, 1000, 900, 800, 880, 700 and VULCAN XC-72 from Cabot Corporation; #3050B, #3150B, #3250B, #3750B, #3950B, #950, #650B, #970B, #850B, MA-600, MA-230, #4000 and #4010 from Mitsubishi Chemical Corporation; CONDUCTEX SC, RAVEN 8800, 8000, 7000, 5750, 5250, 3500, 2100, 2000, 1800, 1500, 1255 and 1250 from Columbia Carbon Co., Ltd.; and Ketjen Black EC from Lion Akzo Co., Ltd. The carbon black employed can be surface treated with a dispersing agent or the like, grafted with a resin, portion of the surface may be graphite-treated. Further, the carbon black may be dispersed with a binder prior to being added to the coating material. These types of carbon black are employed in a range that does not exceed 50 mass percent with respect to the inorganic powder above and does not exceed 40 percent with respect to the total mass of the nonmagnetic layer. These types of carbon black may be employed singly or in combination. The Carbon Black Handbook compiled by the Carbon Black Association may be consulted for types of carbon black suitable for use in the present invention.

Based on the objective, an organic powder may be added to the nonmagnetic layer. Examples are acrylic styrene resin powders, benzoguanamine resin powders, melamine resin powders, and phthalocyanine pigments. Polyolefin resin powders, polyester resin powders, polyamide resin powders, polyimide resin powders, and polyfluoroethylene resins may also be employed. The manufacturing methods described in Japanese Unexamined Patent Publication (KOKAI) Showa Nos. 62-18564 and 60-255827 may be employed.

Binder resins, lubricants, dispersing agents, additives, solvents, dispersion methods, and the like suited to the magnetic layer may be adopted to the nonmagnetic layer. In particular, known techniques for the quantity and type of binder resin and the quantity and type of additives and dispersant employed in the magnetic layer may be adopted thereto

[Layer Structure]

With respect to the thickness structure of the magnetic recording medium of the present invention, the thickness of the nonmagnetic support ranges from 2 to 100 μm, preferably from 2 to 80 μm. For computer tapes, the nonmagnetic support having a thickness of 3.0 to 10 μm (preferably 3.0 to 8.0 μm, more preferably 3.0 to 5.5 μm) can be employed.

An undercoating layer for improving adhesion between the flexible nonmagnetic support and the nonmagnetic layer or magnetic layer may be provided. The thickness of the undercoating layer ranges from 0.01 to 0.5 μm, preferably from 0.02 to 0.5 μm. The magnetic recording medium of the present invention normally may be a disk-shaped medium with double-sided magnetic layers in which a nonmagnetic layer and magnetic layer are provided on both sides of the support, or may have these layers on just one side. In that case, a backcoat layer may be provided to prevent static and correct for curling on the opposite side from the side on which the nonmagnetic layer and magnetic layer are provided. The thickness of this layer ranges from 0.2 to 1.5 μm, preferably from 0.3 to 0.8 μm. Known undercoating layers and backcoat layers may be employed.

The nonmagnetic lower layer of the medium of the present invention has a thickness ranging from 0.2 to 5.0 μm, prefereably from 0.3 to 3.0 μm, further preferably from 1.0 to 2.5 μm. The upper magnetic layer has a thickness ranging from 0.01 to 0.1 μm, preferably from 0.03 to 0.09 μm, further preferably from 0.04 to 0.08 μm.

[Backcoat Layer]

Generally, in magnetic tapes for computer data recording, greater repeat running properties are demanded than is the case for video tapes and audio tapes. To maintain such high running durability, the backcoat layer preferably contains carbon black and inorganic powder.

Two types of carbon black having different average particle sizes are desirably employed in combination. In this case, a microgranular carbon black having an average particle size of 10 to 20 nm and a coarse granular carbon black having an average particle size of 230 to 300 nm are desirably combined for use Generally, the addition of a microgranular carbon black such as that set forth above permits low surface electrical resistivity in the backcoat layer and low optical transmittance. Since many magnetic recording devices employ tape optical transmittance as an actuating signal, in such cases, the addition of microgranular carbon black is particularly effective. Further, the microgranular carbon black generally has a storage ability of liquid lubricants. When employed with a lubricant in combination, it contributes to a reduction in the coefficient of friction. On the other hand, the coarse granular carbon black with a particle size of 230 to 300 nm functions as a solid lubricant, forming micro protrusions on the surface of the back layer that reduce the contact surface area and contribute to a reduction in the coefficient of friction. However, the coarse carbon black has a drawback in that it easily falls down from the backcoat layer due to tape sliding in a severe running system, resulting in increase of error rate.

Specific products of microgranular carbon black are given below; RAVEN2000B (18 nm), RAVEN1500B (17 nm) (the above products are manufactured by Columbia Carbon Co., Ltd.), BP800 (17 nm) (manufactured by Cabot Corporation), PRINTEX90 (14 nm), PRINTEX95 (15 nm), PRINTEX85 (16 nm), PRINTEX75 (17 nm) (the above products are manufactured by Degusa Co.), and #3950 (16 nm) (manufactured by Mitsubishi chemical industry Co., Ltd.).

Specific products of coarse granular carbon black are given below; Thermal Black (270 nm) (manufactured by Cancarb Limited.), RAVEN MTP (275 nm) (manufactured by Columbia Carbon Co., Ltd.).

When employing two types of carbon black with differing average particle sizes in the backcoat layer, the content ratio (by mass) of microgranular carbon black of 10 to 20 nm to coarse granular carbon black of 230 to 300 nm is desirably from 98:2 to 75:25, more preferably from 95:5 to 85:15.

Two types of inorganic powder of differing hardness may be employed in combination. Specifically, a soft inorganic powder with a Mohs' hardness of 3 to 4.5 and a hard inorganic powder with a Mohs' hardness of 5 to 9 are desirably employed.

The addition of a soft inorganic powder with a Mohs' hardness of 3 to 4.5 permits stabilization of the coefficient of friction due to repeat running. Further, with a hardness falling within this range, the sliding guide poles are not shaved. The average particle size of the inorganic powder desirably ranges from 30 to 50 nm.

Examples of soft inorganic powders having a Mohs' hardless of 3 to 4.5 are: calcium sulfate, calcium carbonate, calcium silicate, barium sulfate, magnesium carbonate, zinc carbonate, and zinc oxide. These may be employed singly or in combinations of two or more. Of these, calcium carbonate is particularly preferred.

The content of soft inorganic powder in the backcoat layer preferably ranges from 10 to 140 mass parts, more preferably from 35 to 100 mass parts, per 100 mass parts of carbon black.

The addition of a hard inorganic powder with a Mohs' hardness of 5 to 9 strengthens the backcoat layer and improves running durability. The use of these inorganic powders with carbon black and the above-described soft inorganic powder decreases deterioration due to repeat sliding, yielding a strong backcoat layer. The addition of this inorganic powder imparts a suitable extent of grinding ability, reducing the adhesion of shavings to the tape guide poles or the like. In particular, when combined with a soft inorganic powder (preferably calcium carbonate), the sliding properties against the guide poles with their coarse surfaces is improved, permitting a backcoat layer with a stable coefficient of friction.

The hard inorganic powder desirably has an average particle size of 80 to 250 nm, more preferably 100 to 210 nm.

Examples of hard inorganic powders having a Mohs' hardness of 5 to 9 are: α-iron oxide, α-alumina, and chromium oxide (Cr₂O₃). These powders may be employed singly or in combination. Of these, α-iron oxide and α-alumina are preferred. The content of hard inorganic powder normally ranges from 3 to 30 mass parts, preferably from 3 to 20 mass parts, per 100 mass parts of carbon black.

When employing the soft inorganic powder and the hard inorganic powder together in the backcoat layer, the soft inorganic powder and the hard inorganic powder are desirably selected for use so that the difference in hardness between the soft inorganic powder and hard inorganic powder is equal to or greater than 2 (preferably equal to or greater than 2.5, more preferably equal to or greater than 3).

The above-described two types of inorganic powders of differing Mohs' hardnesses of specified average particle size and the above-described two types of carbon black of differing average particle size are preferably incorporated in the backcoat layer. In this combination, the incorporation of calcium carbonate as the soft inorganic powder is particularly preferred.

It is possible to incorporate lubricants into the backcoat layer. The lubricants may be suitably selected from the examples of lubricants given for use in the above-described nonmagnetic layer and magnetic layer. The lubricants are normally added to the backcoat layer within a range of 1 to 5 mass parts per 100 mass parts of binder.

[Support]

The support employed in the present invention is a nonmagnetic flexible support, and it can be known films such as polyesters such as polyethylene terephthalate and polyethylene naphthalate, polyolefins, cellulose triacetate, polycarbonates, polyamides, polyimides, polyamidoimides, polysulfones, aramides, and aromatic polyamides. These supports may be subjected beforehand to corona discharge treatment, plasma treatment, adhesion-enhancing treatment, heat treatment, dust removal, or the like.

To achieve the objects of the present invention, the surface roughness shape as a nonmagnetic support is freely controlled through the size and quantity of filler added to the support as needed. Examples of such fillers are oxides and carbonates of Ca, Si, Ti and the like, and organic powders such as acrylic-based one. The support desirably has a maximum height SRₘₐₓ equal to or less than 1 μm, a ten-point average roughness SR_{Z} equal to or less than 0.5 μm, a center surface peak height SR_{P} equal to or less than 0.5 μm, a center surface valley depth SR_{V} equal to or less than 0.5 μm, a center-surface surface area SSr equal to or higher than 10 percent and equal to or less than 90 percent, and an average wavelength Sλₐ of 5 to 300 μm. To achieve desired electromagnetic characteristics and durability, the surface protrusion distribution of the support can be freely controlled with fillers. It is possible to control within a range from 0 to 2,000 protrusions of 0.01 to 1 μm in size per 0.1mm².

The F-5 value of the nonmagnetic support employed in the present invention desirably ranges from 0.049 to 0.49 GPa (5 to 50 kg/mm²). The thermal shrinkage rate of the support after 30 min at 100° C. is preferably equal to or less than 3 percent, more preferably equal to or less than 1.5 percent. The thermal shrinkage rate after 30 min at 80° C. is preferably equal to or less than 1 percent, more preferably equal to or less than 0.5 percent. The breaking strength ranges from 0.049 to 0.98 GPa (5 to 100 kg/mm²). The modulus of elasticity preferably ranges from 0.98 to 19.6 GPa (100 to 2,000 kg/mm²). The thermal expansion coefficient ranges from 10⁻⁴ to 10⁻⁸/° C., preferably from 10⁻⁵ to 10⁻⁶/° C. The moisture expansion coefficient is equal to or less than 10⁻⁴/RH percent, preferably equal to or less than 10⁻⁵RH percent. These thermal characteristics, dimensional characteristics, and mechanical strength characteristics are desirably nearly equal, with a difference equal to less than 10 percent, in all in-plane directions.

[Manufacturing Method of Magnetic Recording Medium]

The magnetic recording medium of the present invention can be manufactured by coating and drying coating materials for forming each layer, and the like. The process for manufacturing the coating material comprises at least a kneading step, a dispersing step, and a mixing step to be carried out, if necessary, before and/or after the kneading and dispersing steps. Each of the individual steps may be divided into two or more stages. All of the starting materials employed in the present invention, including the ferromagnetic powder, binders, carbon black, abrasives, antistatic agents, lubricants, solvents, and the like, may be added at the beginning of, or during, any of the steps. Moreover, the individual starting materials may be divided up and added during two or more steps. For example, polyurethane may be divided up and added in the kneading step, the dispersion step, and the mixing step for viscosity adjustment after dispersion.

The organic solvent employed in the manufacturing method of the magnetic recording medium of the present invention may be used in any ratio. Examples are ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutyl alcohol, isopropyl alcohol, and methylcyclohexanol; esters such as methyl acetate, butyl acetate, isobutyl acetate, isopropyl acetate, ethyl lactate, and glycol acetate; glycol ethers such as glycol dimethyl ether, glycol monoethyl ether, and dioxane; aromatic hydrocarbons such as benzene, toluene, xylene, cresol, and chlorobenzene; chlorinated hydrocarbons such as methylene chloride, ethylene chloride, carbon tetrachloride, chloroform, ethylene chlorohydrin, and dichlorobenzene; N,N-dimethylformamide; and hexane. These organic solvents need not be 100 percent pure and may contain impurities such as isomers, unreacted materials, by-products, decomposition products, oxides and moisture in addition to the main components. The content of these impurities is preferably equal to or less than 30 percent, more preferably equal to or less than 10 percent. Preferably the same type of organic solvent is employed in the present invention in the magnetic layer and in the nonmagnetic layer. However, the amount added may be varied. The stability of coating is increased by using a solvent with a high surface tension (such as cyclohexanone or dioxane) in the nonmagnetic layer. Specifically, it is important that the arithmetic mean value of the upper layer solvent composition be not less than the arithmetic mean value of the lower layer solvent composition. To improve dispersion properties, a solvent having a somewhat strong polarity is desirable. It is desirable that solvents having a dielectric constant equal to or higher than 15 are comprised equal to or higher than 50 percent of the solvent composition. Further, the dissolution parameter is desirably from 8 to 11.

For manufacturing the magnetic recording medium of the present invention, conventionally known manufacturing techniques may be utilized for some of the steps. A kneader having a strong kneading force, such as a continuous kneader or pressure kneader is preferably employed in the kneading step for achieving a magnetic recording medium with high residual magnetic flux density (Br). When a continuous kneader or pressure kneader is employed, the ferromagnetic powder and all or part of the binder (preferably equal to or higher than 30 percent of the entire quantity of binder) are kneaded in a range of 15 to 500 mass parts per 100 mass parts of the ferromagnetic powder. Details of the kneading process are described in Japanese Unexamined Patent Publication (KOKAI) Heisei No. 1-106338 and Japanese Unexamined Patent Publication (KOKAI) Showa No. 64-79274. Further, a dispersion medium with a high specific gravity is desirably employed for preparing a nonmagnetic layer coating liquid, and zirconia beads are suitable.

On a nonmagnetic flexible support, a nonmagnetic layer-forming coating liquid comprising nonmagnetic powder and binder and a magnetic layer-forming coating liquid comprising ferromagnetic powder and binder are simultaneously or sequentially coated so that a magnetic layer is formed on a nonmagnetic layer. Methods of smoothing and magnetic field orientation may also be conducted while the coating layers are still wet.

Methods such as the following are desirably employed when coating a multilayer-structured magnetic recording medium as mentioned above;

(1) A method in which the lower layer is first applied with a coating device commonly employed to apply magnetic coating materials such as a gravure coating, roll coating, blade coating, or extrusion coating device, and the upper layer is applied while the lower layer is still wet by means of a support pressure extrusion coating device such as is disclosed in Japanese Examined Patent Publication (KOKOKU) Heisei No. 1-46186 and Japanese Unexamined Patent Publication (KOKAI) Showa No. 60-238179 and Japanese Unexamined Patent Publication (KOKAI) Heisei No. 2-265672;

(2) A method in which the upper and lower layers are applied nearly simultaneously by a single coating head having two built-in slits for passing coating liquid, such as is disclosed in Japanese Unexamined Patent Publication (KOKAI) Showa No. 63-88080, Japanese Unexamined Patent Publication (KOKAI) Heisei No. 2-17971, and Japanese Unexamined Patent Publication (KOKAI) Heisei No. 2-265672; and

(3) A method in which the upper and lower layers are applied nearly simultaneously using an extrusion coating apparatus with a backup roller as disclosed in Japanese Unexamined Patent Publication (KOKAI) Heisei No. 2-174965.

To avoid compromising the electromagnetic characteristics or the like of the magnetic recording medium by aggregation of magnetic particles, shear is desirably imparted to the coating liquid in the coating head by a method such as disclosed in Japanese Unexamined Patent Publication (KOKAI) Showa No. 62-95174 or Japanese Unexamined Patent Publication (KOKAI) Heisei No. 1-236968. In addition, the viscosity of the coating liquid must satisfy the numerical range specified in Japanese Unexamined Patent Publication (KOKAI) Heisei No. 3-8471.

Smoothing may be conducted, for example, by bringing a stainless steel sheet into contact with the surface of a coating layer on a web. Additionally, smoothing may be conducted by a method using a solid smoother described in Japanese Examined Patent Publication (KOKOKU) Showa No. 60-57378; by a method in which coating liquid is scraped off with rod that is stationary, or rotating in the direction opposite the running direction of a web, and measured; or by a method in which the surface of the coating liquid film is smoothened by contact with a flexible sheet.

Magnetic field orientation is desirably conducted by the joint use of a solenoid of equal to or greater than 100 mT and a cobalt magnet of equal to or greater than 200 mT with like poles opposed. When applying the present invention to a disk medium, it is necessary to employ a method of random orientation.

The coefficient of friction of the magnetic layer surface and the opposite surface of the magnetic recording medium of the present invention with respect to SUS420J is desirably equal to or less than 0.5, preferably equal to or less than 0.3. The specific surface resistivity thereof is desirably from 10⁴ to 10¹² ohm/sq. The modulus of elasticity at 0.5 percent elongation of the magnetic layer is desirably from 0.98 to 19.6 GPa (100 to 2,000 kg/mm²) in both the running direction and width direction. The breaking strength thereof is desirably 0.0098 to 0.294 GPa (1 to 30 kg/cm²). The modulus of elasticity of the magnetic recording medium is desirably 0.98 to 14.7 GPa (100 to 1,500 kg/mm²) in both the running direction and longitudinal direction. The residual elongation thereof is desirably equal to or less than 0.5 percent. The thermal shrinkage rate thereof at any temperature equal to or less than 100° C. is desirably equal to or less than 1 percent, preferably equal to or less than 0.5 percent, and most preferably, equal to or less than 0.1 percent. The glass transition temperature of the magnetic layer (the peak loss of elasticity based on measurement of dynamic viscoelasticity at 110 Hz) is desirably equal to or greater than 50° C. and equal to or less than 120° C., and that of the nonmagnetic layer is desirably from 0° C. to 100° C. The loss elastic modulus desirably falls within a range of 1 to 8×10⁷ mN/cm² (1×10² to 8×10⁹ dyn/cm²), and the loss tangent is desirably equal to or less than 0.2. A high loss tangent tends to compromise viscosity.

The residual solvent in the magnetic layer is preferably equal to or less than 100 mg/m² and more preferably equal to or less than 10 mg/m². The void ratio in the magnetic layers, including both the lower layer and the magnetic layer, is preferably equal to or less than 30 volume percent, more preferably equal to or less than 20 volume percent. Although a low void ratio is preferable for attaining high output, there are some cases in which it is better to ensure a certain level based on the object. For example, in many cases, larger void ratio permits preferred running durability in disk media in which repeat use is important. With respect to the magnetic characteristics of the magnetic recording medium of the present invention, it is suitable that the squareness in the tape running direction is equal to or higher than 0.70, preferably equal to or higher than 0.80, more preferably equal to or higher than 0.85, as measured in the magnetic field of 15.92 kA/m (5 kOe).

Squareness in the two directions perpendicular to the tape running direction is preferably equal to or less than 80 percent of the squareness in the running direction. The switching field distribution (SFD) of the magnetic layer is preferably equal to or less than 0.6.

The magnetic recording medium of the present invention has a lower nonmagnetic layer and an upper magnetic layer. It will be readily understood that the physical characteristics of the magnetic layer and the nonmagnetic layer may be varied based on the objective. For example, the modulus of elasticity of the magnetic layer may be increased to enhance running durability while at the same time decreasing the modulus of elasticity of the lower layer to improve the head contact of the magnetic recording medium. Known techniques relating to multilayered magnetic layer may be referred to for the types of physical characteristics that can be imparted to the various layers of a magnetic layer comprising two or more layers. For example, there are numerous inventions describing the use of a higher Hc in the upper magnetic layer greater than in the lower magnetic layer, such as Japanese Examine Patent Publication (KOKOKU) Showa No. 37-2218 and Japanese Unexamined Patent Publication (KOKAI) Showa No. 58-56228. The use of a thin magnetic layer such as in the present invention permits the recording of magnetic layers of relatively high Hc levels.

[Embodiments]

Embodiments of the present invention will be shown below, but the present invention should not be limited thereto. Unless specifically stated otherwise, “parts” refers to “mass parts” in the embodiments.

Embodiment 1

<Preparation of Coating Material>

Magnetic coating material 1 (hexagonal ferrite: disk)

Magnetic coating material 1 (hexagonal ferrite: disk)

| | | |
|---|---|---|
| Barium ferrite magnetic powder: | 100 | parts |
| Hc 175.2 kA/m | | |
| Plate diameter: 0.03 μm | | |
| Plate ratio: 3 | | |
| σ s: 50 A · m²/kg (50 emu/g) | | |
| Specific surface area: 55 m²/g | | |
| Vinyl chloride copolymer | 5 | parts |
| MR555 (manufactured by Nippon Zeon Co., Ltd.) | | |
| Polyurethane resin | 3 | parts |
| UR8200 (manufactured by Toyobo Co., Ltd.) | | |
| α-alumina | 10 | parts |
| HIT50 (manufactured by Sumitomo Chemical | | |
| Co., Ltd.) | | |
| Particle size: 0.2 μm | | |
| Carbon black | 1 | part |
| #55 (manufactured by Asahi Carbon Co., Ltd.) | | |
| Average primary particle diameter: 0.075 μm | | |
| Specific surface area: 35 m²/g | | |
| DBP oil absorption capacity: 81 ml/100 g | | |
| pH: 7.7 | | |
| Volatile content: 1.0 percent | | |
| Butyl stearate | 10 | parts |
| Butoxyethyl stearate | 5 | parts |
| Isohexadecyl stearate | 3 | parts |
| Stearic acid | 2 | parts |
| Methyl ethyl ketone | 25 | parts |
| Cyclohexanone | 25 | parts |

Nonmagnetic coating material 1 (for nonmagnetic layer: disk)

| | | |
|---|---|---|
| Nonmagnetic powder TiO₂, crystal type rutile | 80 | parts |
| Average primary particle diameter: 0.035 μm | | |
| Specific surface area by BET method: 40 m²/g | | |
| pH:7 | | |
| TiO₂ content: equal to or higher than 90 percent | | |
| DBP oil absorption capacity: 27 to 38 g/100 g | | |
| Surface treatment agent: Al₂O₃, 8 mass percent | | |
| Carbon black | 20 | parts |
| Conductex SC-U (manufactured by Columbia | | |
| Carbon Co., Ltd.) | | |
| Average primary particle diameter: 0.020 μm | | |
| Specific surface area: 220 m²/g | | |
| DBP oil absorption capacity: 115 ml/100 g | | |
| pH: 7.0 | | |
| Volatile content: 1.5 percent | | |
| Vinyl chloride copolymer | 12 | parts |
| MR110 (manufactured by Nippon Zeon Co., Ltd.) | | |
| Polyurethane resin | 5 | parts |
| UR8200 (manufactured by Toyobo Co., Ltd.) | | |
| Phenylphosphorous acid | 4 | parts |
| Butyl stearate | 10 | parts |
| Butoxyethyl stearate | 5 | parts |
| Isohexadecyl stearate | 2 | parts |
| Stearic acid | 3 | parts |
| Methyl ethyl ketone/cyclohexanone (1/1 mixed solvent) | 250 | parts |

Manufacturing Method 1: Disks

Of the above-listed coating materials, 150 parts of the magnetic material, α-alumina, carbon black, vinyl chloride copolymer, and solvent were kneaded in a kneader, the remaining components were added, and the mixture was dispersed for 24 hours in a sand mill. Polyisocyanate was added to the dispersion obtained: 10 parts to the nonmagnetic layer coating liquid and 10 parts to the magnetic layer coating liquid. Forty parts of cyclohexanone were then added to each. The mixtures were then filtered through a filter having an average pore size of 1 μm to obtain nonmagnetic layer-forming and magnetic layer-forming coating liquids. The nonmagnetic layer-forming coating liquid obtained was directly applied in a quantity yielding a thickness of 1.5 μm upon drying, and immediately thereafter, the magnetic layer-forming coating liquid was applied in a quantity yielding a thickness of 0.15 μm, to a polyethylene terephthalate support 62 μm in thickness having a center surface average roughness of 3 nm in simultaneous multilayer coating. While both layers were still wet, they were passed through an alternating magnetic field generating device having the two magnetic field intensities of 50 Hz frequency, 25 mT (250 Gauss) and 50 Hz frequency, 12 mT (120 Gauss) to conduct random orientation. After drying, they were processed with a seven-stage calender at 90° C. and a linear pressure of 2,942 N/cm (300 kg/cm), punched to 3.5 inches, and surface polished, yielding a disk medium.

Magnetic coating material 2 (hexagonal ferrite: tape)

| | | |
|---|---|---|
| Barium ferrite magnetic powder | 100 | parts |
| Hc: 175.2 kA/m | | |
| Plate diameter: 0.03 μm | | |
| Plate ratio: 3 | | |
| σ s 50 A - m²/kg (50 emu/g) | | |
| Specific surface area: 55 m²/g | | |
| Vinyl chloride copolymer | 6 | parts |
| MR555 (manufactured by Nippon Zeon Co., Ltd.) | | |
| Polyurethane resin | 3 | parts |
| UR8200 (manufactured by Toyobo Co., Ltd.) | | |
| α-alumina (particle size: 0.2 μm) | 2 | parts |
| HIT60A (manufactured by Sumitomo Chemical Co., Ltd.) | | |
| Carbon black (particle size: 0.015 μm) | 5 | parts |
| #55 (manufactured by Asahi Carbon Co., Ltd.) | | |
| Butyl stearate | 1 | part |
| Stearic acid | 2 | parts |
| Methyl ethyl ketone | 125 | parts |
| Cyclohexanone | 125 | parts |

Nonmagnetic coating material 2 (for nanmagnetic layer: tape)

| | | |
|---|---|---|
| Nonmagnetic powder TiO₂, crystal type rutile | 80 | parts |
| Average primary particle diameter: 0.035 μm | | |
| Specific surface area by BET method: 40 m²/g | | |
| pH: 7 | | |
| TiO₂ content: equal to or higher than 90 percent | | |
| DBP oil absorption capacity: 27 to 38 g/100 g | | |
| Surface treatment agent: Al₂O₃, 8 mass percent | | |
| Carbon black | 20 | parts |
| Conductex SC-U (manufactured by Columbia | | |
| Carbon Co., Ltd.) | | |
| Vinyl chloride copolymer | 12 | parts |
| MR110 (manufactured by Nippon Zeon Co., Ltd.) | | |
| Polyurethane resin | 5 | parts |
| UR8200 (manufactured by Toyobo Co., Ltd.) | | |
| Phenylphosphorous acid | 4 | parts |
| Butyl stearate | 1 | part |
| Stearic acid | 3 | parts |
| Methyl ethyl ketone/cyclohexanone (1/1 mixed solvent) | 250 | parts |

Manufacturing Method 2: Computer Tape

Each component of the above-described coating materials was kneaded in a kneader and then dispersed in a sand mill for 20 hours. Polyisocyanate was added to the dispersions obtained: 2.5 parts to the coating liquid for the nonmagnetic layer and 3 parts to the coating liquid for the magnetic layer. A further 40 parts of cyclohexanone were then added to each and the mixtures were filtered through a filter having an average pore size of 1 μm to prepare nonmagnetic layer-forming and magnetic layer-forming coating liquids. The nonmagnetic layer-forming coating liquid obtained was directly applied in a quantity yielding a nonmagnetic layer with a thickness of 1.7 μm upon drying, and immediately thereafter, the magnetic layer-forming coating liquid was applied in a quantity yielding a magnetic layer with a thickness of 0.15 μm, to an aramide support (product name: Mictron) 4.4 μm in thickness having a center surface average roughness of 2 nm in simultaneous multilayer coating. While both layers were still wet, they were oriented with a cobalt magnet having a magnetic intensity of 600 mT and a solenoid having a magnetic intensity of 600 mT. After drying, they were processed with a seven-stage calender comprised only of metal rolls at 85° C. and a linear pressure of 2,942 N/cm (300 kg/cm). Subsequently, a back layer 0.5 μm in thickness (100 parts carbon black (average particle size: 17 nm) and 5 parts α-alumina (average particle size: 200 nm) dispersed in nitrocellulose, 15 parts polyurethane resin, and 40 parts polyisocyanate) was applied. It was then slit into a 3.8 mm width, and fixed in a device having a device passing and winding the slit product so as to contact a nonwoven fabric and a razor blade with a magnetic surface. The magnetic layer surface was cleaned with a tape-cleaning device to obtain a tape sample.

Embodiment 3

A disk was obtained in the same manner as in Embodiment 1 with the exception that 17 parts of butyl stearate were employed in magnetic coating material 1.

Embodiment 4

A tape was obtained in the same manner as in Embodiment 2 with the exception that 0.6 part of butyl stearate was employed in magnetic coating material 2.

Embodiment 5

A tape was obtained in the same manner as in Embodiment 2 with the exception that 1.5 parts of butyl stearate were employed in magnetic coating material 2.

Embodiment 6

A disk was obtained in the same manner as in Embodiment 1 with the exception that 36 parts of alumina (HIT50 made by Sumitomo Chemical Co., Ltd.) were employed in magnetic coating material 1.

### COMPARATIVE EXAMPLE 1

A disk was obtained in the same manner as in Embodiment 1 with the exception that 21 parts of butyl stearate were employed in magnetic coating material 1.

### COMPARATIVE EXAMPLE 2

A tape was obtained in the same manner as in Embodiment 2 with the exception that 0.3 part of butyl stearate was employed in magnetic coating material 2.

### COMPARATIVE EXAMPLE 3

A tape was obtained in the same manner as in Embodiment 2 with the exception that 61 parts of alumina (HIT60A made by Sumitomo Chemical Co., Ltd.) were employed in magnetic coating material 2.

### COMPARATIVE EXAMPLE 4

A tape was obtained in the same manner as in Embodiment 2 with the exception that dispersion was conducted in a sand mill for 6 hours.

### COMPARATIVE EXAMPLE 5

A disk was obtained in the same manner as in Embodiment 1 with the exceptions that dispersion was conducted for 15 hours in a sand mill and calendering was conducted at a linear pressure of 2,256 N/cm (230 kg/cm).

Measurement Methods

The performance of the above-described magnetic disks and computer tapes that had been prepared was evaluated by the following measurement methods.

(1) Surface Lubricant Index

(i) Auger Electron Spectroscopy

The sample was divided in two, one part (a) was left unaltered, the lubricant component was removed from the other part (b) by the following method, and measurements were taken with an Auger electron spectroscopic analyzer.

Measurement Conditions

Auger electron spectroscopic analyzer: Auger electron spectroscopic analyzer made by Φ Co. of the U.S. (Model pHI-660)

Primary electron acceleration: 3 kV

Sample current: 130 mA

Magnification: 250-fold

Incline angle: 30°

Kinetic energy: 130-730 eV

Cumulative trials: 3

The intensity of the KLL peak of carbon (C) and the intensity of the LMM peak of iron (Fe) were calculated as differentials, the ratio of C/Fe was obtained, and the intensity ratio of (a) and (b), (C/Fe(a)/C/Fe(b)) was calculated as the surface lubricant index.

(ii) Method of Removing Lubricant Components

The sample (10×30 mm) was immersed in n-hexane at ordinary temperature for 30 minutes to extract and remove unadsorbed fatty acids and fatty esters. Next, the sample was placed in a test tube, 10 mL of n-hexane and 0.3 mL of a derivative-generating reagent in the form of the silylating agent TMSI-H (hexamethyldisilazane (HMDS): trimethyl-chlorosilane (TMCS): pyridine mixture, made by GL Science Co.) were added, and a derivative-generating reaction was conducted with heating at 60° C. for one hour. The reagent was removed and the reaction product was washed with ethanol and dried to remove the lubricant components.

(2) Measurement of the center surface average roughness SRa

The center surface average roughness SRa was measured by AFM.

Device: Nanoscope III made by Japan Veeco Co., Ltd.

Mode:AFM mode (contact mode)

Measurement scope: 40 μm square

Scan line: 512*512

Scan speed: 2 Hz

(3) Measurement of S/N Ratio

(i) Disk

A recording head ((metal in gap (MIG), gap 0.15 μm, 1.8 T) and a reproduction MR head were mounted on a spin stand and measurements were conducted. A signal was written at a track width of 2.3 μm, a rotational speed of 3,600 rpm, a radius of 30 mm, and a linear recording density of 100 kFCI. The output obtained with a spectrum analyzer and the noise level of the 0.5 to 22 MHz bandwidth were measured, and the S/N value was calculated.

(ii) Tape

A tape feeding device equipped with the head guide assembly of a linear head system on which a commercial MR head was mounted was employed. A signal with a recording wavelength of 0.2 μm was written at a tape feed speed of 3 m/sec at a write track width of 27 μm. The signal was reproduced with a MR head having a track width of 12.5 μm. The output obtained and noise level in the 0 to 12 MHz band width were measured with a spectrum analyzer, and the S/N value was calculated.

(4) Evaluation of Durability

(i) Evaluation of Disk System: Durability

A floppy disk drive (ZIP100, rotational speed 2,968 rpm, made by Iomega Co. (U.S.)) was employed. The head was secured at a 38 mm radial position, recording was conducted at a recording density of 34 kfci, and the signal reproduced was adopted as 100 percent. Subsequently, running was conducted for 1,000 hours in a thermocycle environment with the flow given below defined as one cycle. The output was monitored every 24 hours of run time, and failure was deemed to occur at the point where the output dropped to 70 percent or less of the initial value.

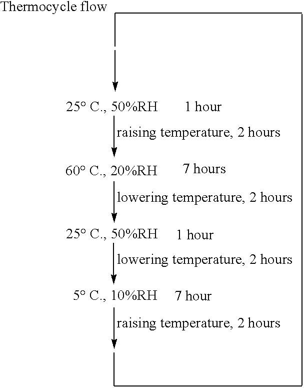

(ii) Evaluation of Tape System: Magnetic Surface μ Value

For durability, SUS420J of 4 mm φ was employed, the tape was suspended with a wrap angle of 90° at 23° C. and 70% RH, the back surface was run with a load of 10 g, and the coefficient of friction was calculated using Euler's Equation from the resulting change in tension. The number of running pass is one pass and 500 passes.

The results are given in Table 1.

TABLE 1

| | | | | | Tape durability | | |
|---|---|---|---|---|---|---|---|
| | | | | | (magnetic | | |
| | | Surface | | Surface | surface μ value) | | Disk |
| | | lubricant | S/N | roughness | 1 | 500 | durability |
| | Type | index | (dB) | Ra (nM) | pass | passes | (hour) |
| Embodiment 1 | Disk | 3.01 | 26.0 | 2.6 | — | — | 670 |
| Embodiment 2 | Tape | 2.96 | 25.0 | 2.3 | 0.23 | 0.29 | — |
| Embodiment 3 | Disk | 4.86 | 25.8 | 2.2 | — | — | 550 |
| Embodiment 4 | Tape | 1.34 | 25.1 | 2.1 | 0.24 | 0.29 | — |
| Embodiment 5 | Tape | 3.24 | 24.9 | 2.3 | 0.25 | 0.33 | — |
| Embodiment 6 | Disk | 2.95 | 23.3 | 3.6 | — | — | 685 |
| Comp.Ex.1 | Disk | 6.29 | 24.9 | 2.2 | — | — | 0 |
| | | | | | | | (Sticking |
| | | | | | | | at start) |
| Comp.Ex.2 | Tape | 1.1 | 25.0 | 2.5 | 0.35 | Sticking | — |
| Comp.Ex.3 | Tape | 2.87 | 20.3 | 4.3 | 0.22 | 0.26 | — |
| Comp.Ex.4 | Tape | 2.86 | 19.8 | 6.3 | 0.22 | 0.27 | — |
| Comp.Ex.5 | Disk | 3.13 | 21.3 | 5.7 | — | — | 605 |

Evaluation Results

Embodiments 1 to 6, in which hexagonal ferrite was employed in the magnetic layer, the surface lubricant index of the magnetic layer was kept within a range of 1.3 to 5.0, and the center surface average roughness SRa of an area 40×40 μm measured by AFM did not exceed 4 nm, had high S/N ratios (equal to or greater than 23 dB for the disks, equal to or greater than 22 dB for the tapes) and good electromagnetic characteristics. Further, repeat running did not result in sticking and good running properties were achieved.

Comparative Example 1, an example in which the surface lubricant index exceeded the range of the present invention, exhibited sticking at the outset of running due to the presence of a large quantity of lubricant on the surface.

Comparative Example 2, an example in which the surface lubricant index fell short of the range of the present invention, exhibited sticking as the number of passes increased due to a small quantity of surface lubricant.

Comparative Example 3 is an example in which the quantity of α-alumina contained in the magnetic coating material was high and the center surface average roughness SRa of the magnetic layer exceeded the range of the present invention. Comparative Example 4, an example corresponding to Embodiment T2 of Japanese Unexamined Patent Publication (KOKAI) Heisei No. 10-302243, was inadequately dispersed and exhibited a center surface average roughness SRa exceeding the range of the present invention due to a short period of dispersion in a sand mill. Comparative Example 5 is an example in which the magnetic layer exhibited a center surface average roughness SRa exceeding the range of the present invention due to a short period of dispersion in a sand mill and the use of calendering at low pressure. Comparative Examples 3 to 5 all had magnetic layers with high center surface average roughness SRa levels, resulting in spacing loss, high carrier proximity noise, and decreased S/N ratios.

The present invention can provide a magnetic recording medium with excellent electromagnetic characteristics, as well as with good still characteristics, low coefficient of friction, and excellent running properties.

The present disclosure relates to the subject matter contained in Japanese Patent Application No. 2001-328137 filed on Oct. 25, 2001, which is expressly incorporated herein by reference in its entirety.

What is claimed is:

1. A magnetic recording medium comprising a nonmagnetic layer comprising a nonmagnetic powder and a binder and a magnetic layer comprising a hexagonal ferrite powder and a binder in this order on a support, wherein
said magnetic layer has a surface lubricant index ranging from 1.3 to 5.0 and a center surface average roughness SRa of a 40×40 μm area as measured by atomic force microscope (AFM) being equal to or less than 4 nm.

2. The magnetic recording medium according to claim 1, wherein said surface lubricant index ranges from 1.3 to 3.0.

3. The magnetic recording medium according to claim 1, wherein said center surface average roughness SRa is equal to or less than 3 nm.

4. The magnetic recording medium according to claim 1, wherein said hexagonal ferrite powder has a hexagonal plate diameter ranging from 10 to 100 nm.

5. The magnetic recording medium according to claim 1, wherein said hexagonal ferrite powder has a hexagonal plate diameter ranging from 10 to 60 nm.

6. The magnetic recording medium according to claim 1, wherein said hexagonal ferrite powder has a hexagonal plate diameter ranging from 10 to 50nm.

7. The magnetic recording medium according to claim 1, wherein said magnetic layer further comprises an abrasive.

8. The magnetic recording medium according to claim 7, wherein said abrasive has a particle diameter ranging from 0.1 to 0.5 μm.

9. The magnetic recording medium according to claim 7, wherein said abrasive has a particle diameter ranging from 0.1 to 0.25 μm.

10. The magnetic recording medium according to claim 7, wherein said abrasive is employed in a proportion of 2 to 50 mass parts per 100 mass parts of said hexagonal ferrite powder.

11. The magnetic recording medium according to claim 7, wherein said abrasive is employed in a proportion of 5 to 30 mass parts per 100 mass parts of said hexagonal ferrite powder.

12. The magnetic recording medium according to claim 1, further comprising a backcoat layer on the opposite side from the side on which the nonmagnetic layer and magnetic layer are comprised.

13. The magnetic recording medium according to claim 12, wherein said backcoat layer comprises carbon black and an inorganic powder.

14. The magnetic recording medium according to claim 13, wherein said carbon black comprises a microgranular carbon black with an average particle size ranging from 10 to 200 nm and a coarse granular carbon black with an average particle diameter ranging from 230 to 300 nm.

15. The magnetic recording medium according to claim 13, wherein said inorganic powder comprises a soft inorganic powder with a Mohs' hardness ranging from 3 to 4.5 and a hard inorganic powder with a Mohs' hardness ranging from 5 to 9.

16. A method of recording and reproduction of the magnetic recording medium according to claim 1, wherein an MR head is employed as the recording and reproduction means.
